(19) United States
(12) Patent Application Publication
(10) Pub. No.: US 2020/0049275 A1
(43) Pub. Date: Feb. 13, 2020

(54) BALL VALVE POSITIONING STRUCTURE

(71) Applicant: YEK HWA HARDWARE CO., LTD., Taipei (TW)

(72) Inventor: Chao-Hsiung Chen, Taipei (TW)

(21) Appl. No.: 16/503,431

(22) Filed: Jul. 3, 2019

(30) Foreign Application Priority Data
Aug. 9, 2018 (TW) 107210924

(51) Int. Cl. F16K 31/60; F16K 5/06; F16K 3/314; F16K 27/06

(52) U.S. Cl. CPC F16K 31/605; F16K 27/067; F16K 3/314; F16K 5/06

(57) ABSTRACT

A ball valve positioning structure is mainly configured with a main body having a water entrance and water exit. the top end of a rotating shaft of the main body is configured with a handle, through the rotation of which allows the main body to be opened or closed, where the circumference of a housing aperture configured on the upper side of the main body is configured with stop levers and a fastening portion; the tail end of the handle is configured with a propping portion, and the handle a through hole and put around with a holding ring. Whereby, the stop levers are used to limit the propping portion, allowing the handle to be rotated 180 degrees so that the ball valve can be opened by turning the handle leftward or rightward to match with different construction occasions.

### (a) TECHNICAL FIELD OF THE INVENTION

The present invention relates to a ball valve positioning structure, and more particularly to a ball valve positioning structure capable of being combined with different occasions to open in a leftward or rightward rotation way and capable of being locked to prevent it from being improperly removed.

### (b) DESCRIPTION OF THE PRIOR ART

The main characteristics of ball valves are their compact structures, easy operations and maintenances and suitability for general working media such as water, solvents, acids and natural gas, and capability of working with media suitable for working in harsh conditions such as oxygen, hydrogen peroxide, methane and ethylene. The ball valve is mainly used in the pipeline to cut, distribute and change the flow direction of the medium. The main structure of the ball valve is configured with a ball with an opening on it, and a spherical surface should be presented at both the entrance and exit when ball is rotated 90 degrees with the handle that can drive the ball so as to cut the flow, and the opening of the ball is parallel to the axle center of the valve door to form a passage when the ball is rotated back. The ball valve can be closed tightly only with a 90 degrees rotation operation and a very small rotation torque. The fully equal valve body cavity provides a straight flow passage with very small resistance. The working principle of the ball valve depends on the rotation of the valve body to make the valve door open or close. The ball valves are broadly used in every industry because they are light in opening and closing and small in volume, can be made into a very large diameter body, are simple in structure, convenient in maintenance, and the sealing face and spherical face are always in a close state and thus not easily eroded by medium.

However, conventional ball valve handles can only be rotated 90 degrees, i.e. they can only be used for unidirectional rotation such that when the installed position cannot match this direction of rotation, it will cause construction questions. Furthermore, conventional ball valves are not provided with other additional functions especially a position locking function other than fluid control. Therefore, if the ball valve is improperly pulled upon use, the normal operations may be affected, and unexplained loss may even be caused.

### SUMMARY OF THE INVENTION

To overcome the disadvantages mentioned above, the present invention is proposed.

The main object of the present invention is to provide a ball valve positioning structure, allowing a ball valve handle to be rotated 180 degrees so as to match different construction occasions, opening the ball valve leftward or rightward, and capable of positioning the handle so as to prevent the handle from being improperly removed, and to increase practicality of the ball valve.

To achieve the above object, the present invention proposes a ball valve positioning structure, configured with a main body having a water entrance and water exit, a housing aperture formed 90 degrees with the water entrance and water exit being configured on a upper side of the main body, a ball having an opening being configured inside the main body, a rotating shaft of the ball locked to a handle after passed through the housing aperture of the main body, the handle driving the rotating shaft to rotate, a tail end of the handle configured with a downwardly bended propping portion, the opening on the ball caused to be parallel or perpendicular to the water entrance and water exit through the rotation of the handle to form a passage or block the opening to form an open state or close state, wherein a circumference of the housing aperture is respectively configured with stop levers and fastening portion, the handle is put around with a holding ring movable along the handle, the stop levers are used to limit the propping portion on the tail end of the handle, allowing the handle to be rotated 180 degrees, and further allowing the ball valve to be opened by leftward or rightward rotation of the handle to match with different construction occasions, and the holding ring is fastened to the fastening portion in an open state so as to constitute handle positioning.

According to the ball valve positioning structure mentioned above, the fastening portion is two symmetrically arranged rods.

According to the ball valve positioning structure mentioned above, the holding ring is configured with a ring body, a bottom edge of the ring body is extended with a curved sheet, the ring body is movable along the handle by putting the ring body around the handle, and a positioning is formed by embedding the sheet in between the two rods of the fastening portion.

According to the ball valve positioning structure mentioned above, the handle is configured with a through hole, allowing a lock to be passed through the through hole after the holding ring is fastened to the fastening portion, allowing the holding ring not to be pulled, and further allowing the sheet of the holding ring not to be separated from the fastening portion so as to prevent the handle from being improperly removed.

### BRIEF DESCRIPTION OF THE DRAWINGS

FIG. 1 is a perspective view of the present invention;

FIG. 2 is a top view of the present invention;

FIG. 3 is a top view of the present invention in an operation state;

FIGS. 4 and 5 respectively are a perspective view and schematic view of the present invention, showing a fastening action; and

FIG. 6 is a schematic view of the present invention in a locking positioning state.

### DETAILED DESCRIPTION OF THE PREFERRED EMBODIMENTS

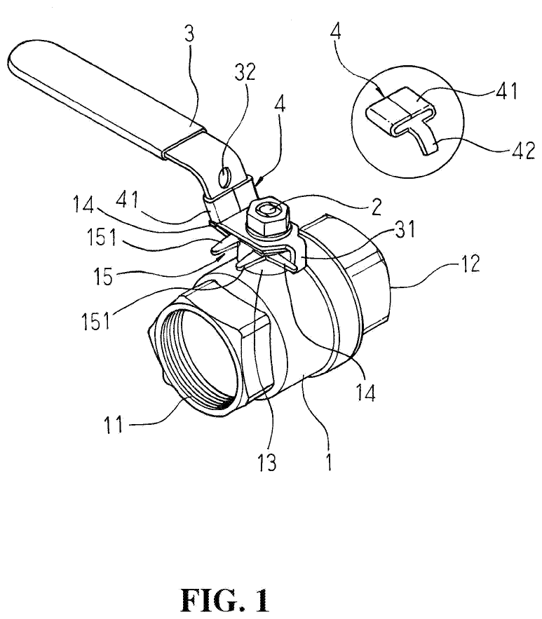

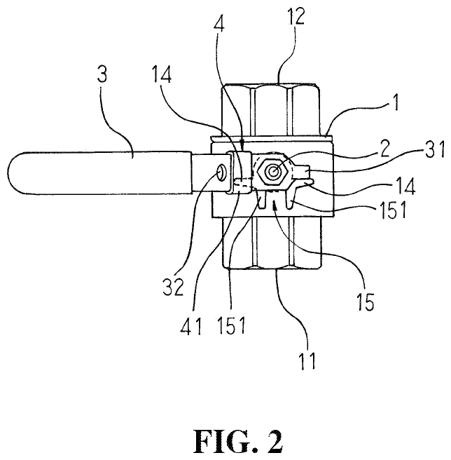

Referring to FIGS. 1 and 2, a ball valve positioning structure of the present invention includes a main body 1, rotating shaft 2 and handle 3.

The main body 1 is configured with a water entrance 11 and water exit 12, where one end of the water entrance 11 and one end of the water exit 12 are respectively formed with a thread connection end so as to facilitate the connection with pipes of different types. The upper side of the main body 1 is configured with a housing aperture 13, the circumference of which is respectively configured with two stop levers 14 and a fastening portion 15. In a preferred embodiment, the two stop levers 14 are perpendicular to the water entrance 11 and water exit 12, and the fastening portion 15 is two symmetrically arranged rods 151 which are positioned in the same direction as the water entrance 11 and water exit 12. The inside of the main body 1 is configured with a ball having an opening; when the ball is rotated 90 degrees, a spherical face will respectively presented at the entrance and exit so as to cut the water flow; and when the ball is rotated back, the hole on the ball will be parallel to the axle center of a valve door, forming a passage. Since the ball inside the main body 1 is conventional, the detail thereof is omitted here.

The rotating shaft 2 is embedded in the ball inside the main body 1 after passed through the housing aperture 13 of the main body 1.

The handle 3 is formed into a downwardly bended propping portion 31 on the tail end thereof, allowing the rotating shaft 2 to be passed through and fixed to the handle 3, and further allowing the handle 3 to drive the rotating shaft 2 to rotate. The handle 3 is configured with a through hole 32 and put around with a holding ring 4 having a ring body 41 the bottom edge of which is extended with a curved sheet 42 allowed to be moved along the handle 3 by putting the ring body 41 around the handle 3.

With the assembly of the above components, an improved ball valve structure of the present invention is constituted. The opening of the ball is allowed to be parallel to the water entrance 11 and water exit 12 of the main body 1 through the rotation of the handle 3 to form a passage, constituting an opening, or a spherical face is presented at both the water entrance 11 and water exit 12 through another rotation of the ball to block the passage to cut the water flow, constituting an closing (this is a conventional structure). Furthermore, the two stop levers 14 configured on the two sides of the housing aperture 13 are used to form limits to the propping portion 31 on the tail end of the handle 3 during the rotation, allowing the handle 3 to be rotated 180 degrees, and further allowing the ball valve to be rotated to open leftward or rightward according to different occasions. In addition, the holding ring 4 is fastened to the fastening portion 15 in an open state, and a lock is passed through the through hole 32 of the handle 3, allowing the holding ring 4 not to be pulled to prevent the handle 3 to be improperly removed to further increase the practical value of the ball valve.

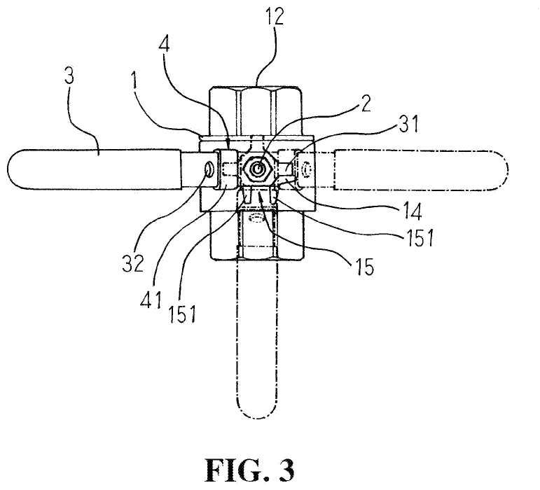

Referring to FIG. 3 and to FIG. 1 again, the handle 3, upon use, drives the ball inside the main body 1 to rotate through the rotating shaft 2, where the passage can be formed to allow the water to pass through to form an open state when the ball is rotated to cause the opening to be parallel to the water entrance 11 and water exit 12 (at this time, the handle 3 is parallel to the main body 1), and the passage is blocked to form a close state when the ball is rotated to cause the opening to be perpendicular to the water entrance 11 and water exit 12 (at this time, the handle 3 is perpendicular to the main body 1). During the above rotations, the propping portion 31 configured on the tail end of the handle 3 will be pressed against the stop lever 14 to form a limit to prevent the handle 3 from being rotated excessively to cause damage when the handle 3 is rotated leftward or rightward (it will be perpendicular to the main body 1 whether rotated leftward or rightward) since the circumference of the housing aperture 13 are configured with the stop levers 14. Thus, the present invention can be increased in practicality without construction questions caused from the conventional ball valves that can only be rotated unidirectionally because the ball valve of the present invention can be opened leftward or rightward.

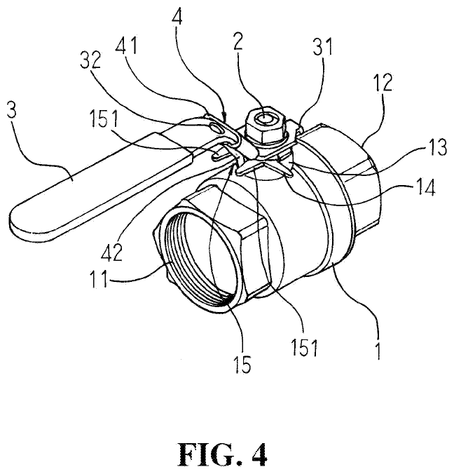

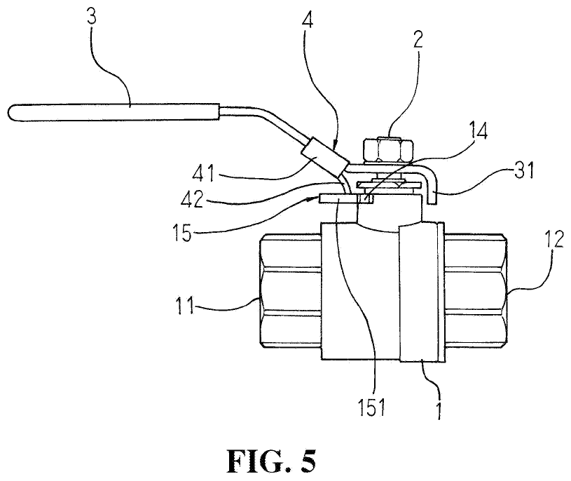

Referring to FIGS. 4 and 5, the holding ring 4 put around the handle 3 can be slid downward along the handle 3 when the present invention is in an open state (the handle 3 is parallel to the main body 1), causing the sheet 42 on the bottom edge thereof to be fastened to the fastening portion 15 (embedded in between the two rods 151 to form a positioning action, preventing the operation from being influenced due to malfunction.

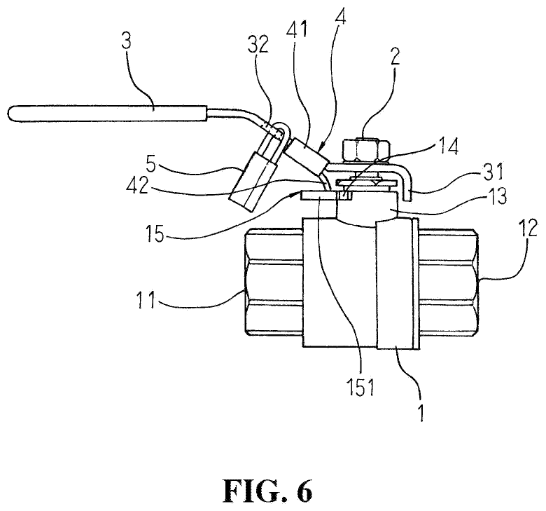

Referring to FIG. 6 and to FIG. 5 again, a simple lock 5 may be passed through and locked in the through hole 32 of the handle 3 after the holding ring 4 is slid downward along the handle 3 and the sheet 42 on the bottom edge thereof is fastened to the fastening portion 15 when the present invention is in an open state, allowing the holding ring 4 to be unable to be pulled, and further allowing the sheet 42 to be unable to be separated from the fastening portion 15 to prevent the handle 3 from being removed, thereby increasing the practical values of the ball valve.

The aforementioned embodiments only illustrate the preferred embodiments of the creation, rather than restricting the scope of the present invention. Any minor modification or alteration will not lose the essence of the present invention, nor will it depart from the spiritual category of the present invention.

To sum up, the present invention uses the main body configured with the symmetrical stop levers and fastening portion to form a ball valve positioning structure with the handle having propping portions, through hole and fastening ring, allowing the handle to be rotated 180 degrees so that the ball valve can be opened by turning the handle leftward or rightward to match with different construction occasions. In addition, the handle can be prevented from being improperly removed in an open state to increase the practicality of the ball valve.

I claim:

1. A ball valve positioning structure, configured with a main body having a water entrance and water exit, a housing aperture formed 90 degrees with said water entrance and water exit being configured on a upper side of said main body, a ball having an opening being configured inside said main body, a rotating shaft of said ball locked to a handle after passed through said housing aperture of said main body, said handle driving said rotating shaft to rotate, a tail end of said handle configured with a downwardly bended propping portion, said opening on said ball caused to be parallel or perpendicular to said water entrance and water exit through the rotation of said handle to form a passage or block said opening to form an open state or close state,
wherein a circumference of said housing aperture is respectively configured with stop levers and fastening portion, said handle is put around with a holding ring movable along said handle, said stop levers are used to limit said propping portion on said tail end of said handle, allowing said handle to be rotated 180 degrees, and further allowing said ball valve to be opened by leftward or rightward rotation of said handle to match with different construction occasions, and said holding ring is fastened to said fastening portion in an open state so as to constitute handle positioning.

2. The structure according to claim 1, wherein said fastening portion is two symmetrically arranged rods.

3. The structure according to claim 1, wherein said holding ring is configured with a ring body, a bottom edge of said ring body is extended with a curved sheet, said ring body is movable along said handle by putting said ring body around said handle, and a positioning is formed by embedding said sheet in between said two rods of said fastening portion.

4. The structure according to claim 1, wherein said handle is configured with a through hole, allowing a lock to be passed through said through hole after said holding ring is fastened to said fastening portion, allowing said holding ring not to be pulled, and further allowing said sheet of said holding ring not to be separated from said fastening portion so as to prevent said handle from being improperly removed.
